(19) United States
(12) Patent Application Publication
(10) Pub. No.: US 2012/0041802 A1
(43) Pub. Date: Feb. 16, 2012

(54) SYSTEMS, METHODS AND COMPUTER PROGRAM PRODUCTS FOR BUSINESS TRANSFORMATION OF BUSINESS PERFORMANCE INDICATORS

(75) Inventors: Joseph M. Caruso, Staatsburg, NY (US); Salvatore Potenza, Milton, NY (US)

(73) Assignee: INTERNATIONAL BUSINESS MACHINES CORPORATION, Armonk, NY (US)

(21) Appl. No.: 13/276,717

(22) Filed: Oct. 19, 2011

Related U.S. Application Data
(63) Continuation of application No. 11/954,065, filed on Dec. 11, 2007.

(51) Int. Cl. G06Q 10/06

(52) U.S. Cl. 705/7.38

(57) ABSTRACT

Systems, methods, and computer program products for business transformation of business performance indicators. Exemplary embodiments include a method for business transformation of business performance indicators, the method including building and refining a process model in a process modeler, defining metrics, key performance indicators and events, and creating metrics for capturing working duration and decision paths, specifying and preparing the process model for deployment, deploying the process model, calculating the working durations, the decision paths and the key performance indicators, measuring the process model real-time and feeding the working duration and decision percentage data into the process modeler.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to IT-enabled business transformation, and particularly to systems, methods, and computer program products for business transformation of business performance indicators.

2. Description of Background

One important aspect of IT enabled business transformation is the feedback of business process measurements into the process for continuous process improvement. Until now measurements have been “after-the-fact”, i.e., they occur monthly or quarterly and are at the end of the reporting period, which is typically too late to fix the business process or prevent exposure to the business environment due to unplanned events. “Real-time” reporting for the process saves time and results in quicker process improvement and therefore yields competitive advantage.

### SUMMARY OF THE INVENTION

Exemplary embodiments include a method for business transformation of business performance indicators, the method including building and refining a process model in a process modeler, defining metrics, key performance indicators and events, and creating metrics for capturing working duration and decision paths, specifying and preparing the process model for deployment, deploying the process model, calculating the working durations, the decision paths and the key performance indicators, measuring the process model real-time and feeding the working duration and decision percentage data into the process modeler.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides systems, methods and computer program products that interlock the operational business measurements with real time capability. As such, process enhancements can be attained by integrating a monitor with an execution process, which provides capability to use workflow for both automation and notification in a real time business environment based on well defined business measurements.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a block diagram a of a system for implementing systems, business transformation of business performance indicators in accordance with exemplary embodiments;

FIG. 2 illustrates a block diagram of a flow for business transformation of business performance indicators in accordance with exemplary embodiments; and

FIG. 3 illustrates a flow chart for a method for business transformation of business performance indicators in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments include systems, methods and computer program products which are implemented for a “business process” in a business environment. In exemplary embodiments, by interlocking the operational business measurements with real time capability, process enhancements can be attained by integrating a monitor with an execution process, which provides capability to use workflow for both automation and notification in a real time business environment based on well defined business measurements.

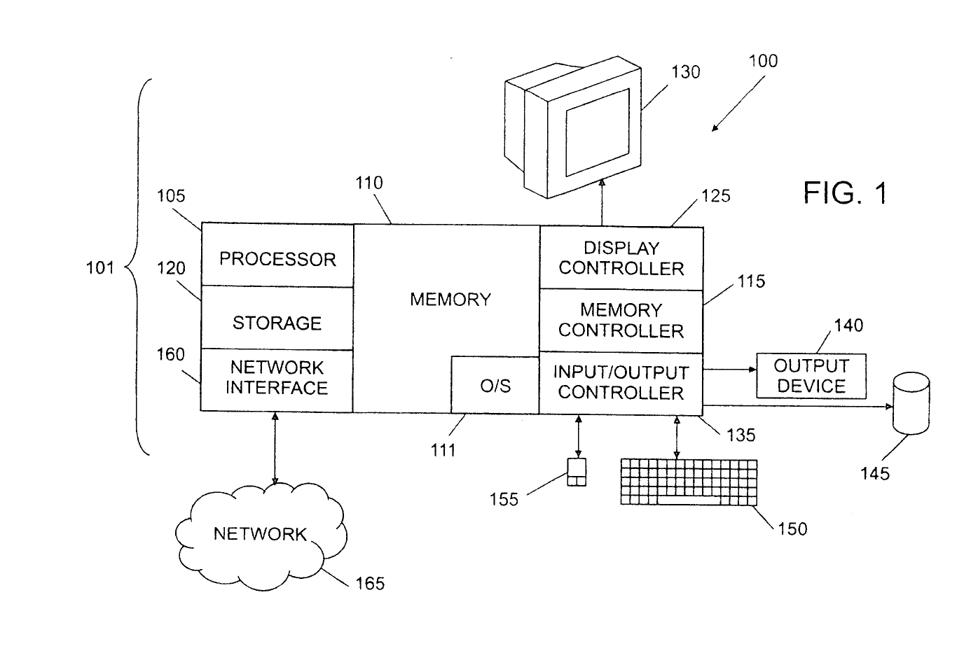

FIG. 1 illustrates a block diagram of a system 100 for implementing systems, business transformation of business performance indicators in accordance with exemplary embodiments. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 101, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the business transformation methods described herein in accordance with exemplary embodiments and a suitable operating system (OS) 111. The operating system 111 essentially controls the execution of other computer programs, such the business transformation systems and methods described herein, and provides scheduling, input-output control, file and data management, memory management, and communication control and related services.

The business transformation methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the O/S 111. Furthermore, the business transformation methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The business transformation methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The business transformation methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the business transformation methods are implemented in hardware, the business transformation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

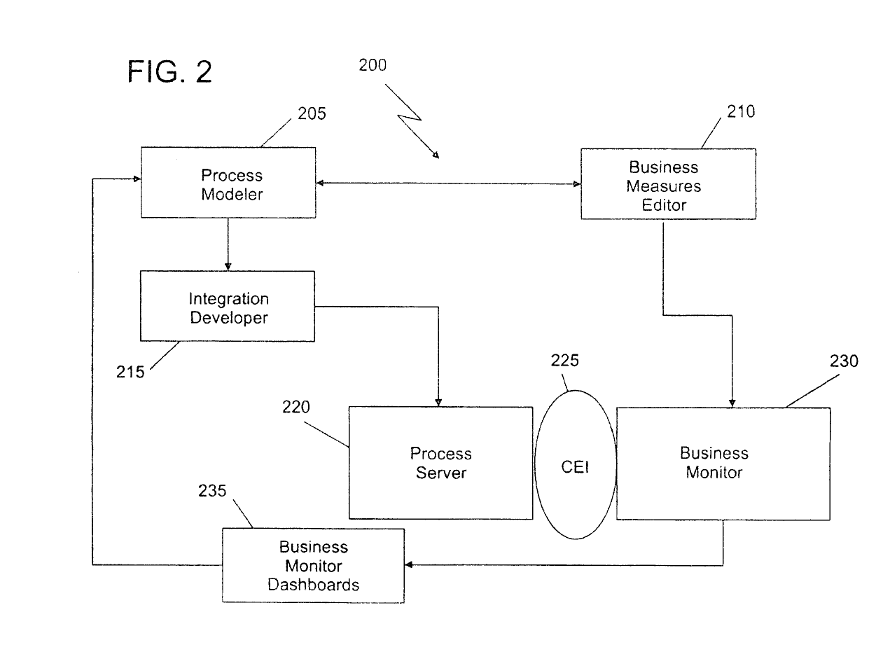

FIG. 2 illustrates a block diagram of a flow 200 for business transformation of business performance indicators in accordance with exemplary embodiments. The flow 200 includes a process modeler 205 in communication with a business measures editor 210 and an integration developer 215. The business measures editor 210 is in communication with a process server. The business measures editor 210 is in communication with a business monitor 230. In exemplary embodiments a common event infrastructure (CEI) 225 is disposed between and in communication with the process server 220 and the business monitor 230. A business monitor dashboards 235 is further in communication with the business monitor 230 and the process modeler.

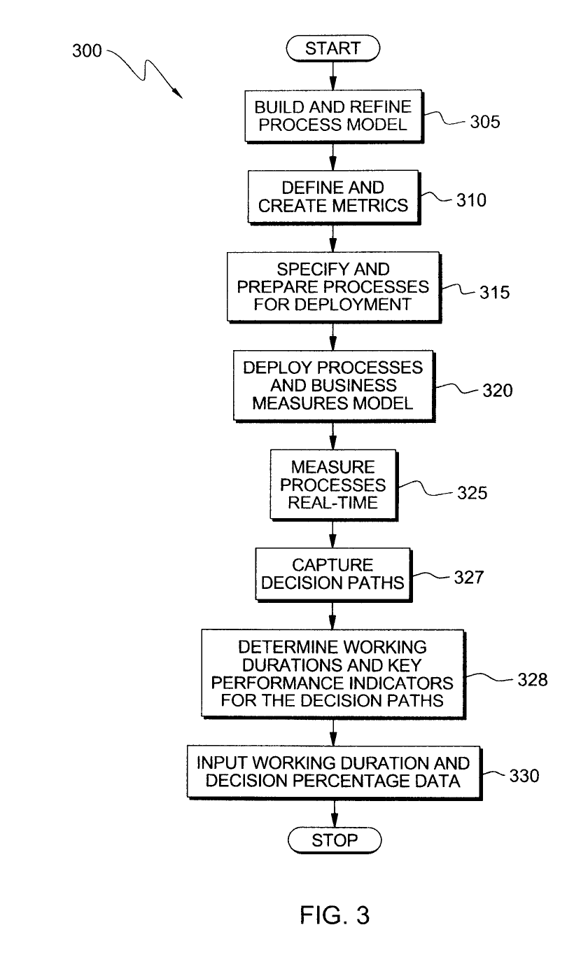

FIG. 3 illustrates a flow chart for a method 300 for business transformation of business performance indicators in accordance with exemplary embodiments. At block 305, the method 300 via the process modeler 205 builds and refines a process model, which includes simulating what-if conditions and selecting processes for monitoring. At block 310, the method 300 via the business measures editor, defines and create metrics (and key performance indicators (KPI) and events) for capturing working duration and decision paths. In exemplary embodiments, an observation model can be generated between the process modeler 205 and the business measures editor 210 via communication and verification between the process modeler 205 and the business measures editor 210. At block 315, the method 300, via the integration developer, further specifies and prepares the processes for deployment. At block 320, the method 300, via the process server 220, deploys the processes and, via the business monitor 230, deploys the business measures model. In exemplary embodiments, the business monitor 230 calculates working durations, decision paths and other KPIs. At block 325, via the business monitor dashboards, the processes are measured real-time. At block 330, the working duration and decision percentage data is fed back into the process modeler 205 to begin the flow over again.

### Example

In exemplary embodiments, a business measurement system can monitor the real time execution of a Sub-Capacity Automation process for IBM zSeries. The monitor is part of a package that is implemented at the time process tools are deployed. In this case existing legacy system transactions were intercepted and routed to a beta version of the Websphere Business Monitor (e.g., the business monitor 230) to demonstrate the benefits of using the Monitor in a legacy business environment. This beta version (6.03) of the Websphere business monitor utilizes leading edge IBM DB2 cubes multidimensional database technology and Alphabox graphic technology.

A team of business process experts, architects, developers and process owners was assembled to define a real time operational business monitor environment. Websphere Business Monitor was implemented to enable the business process environment for future enhancements using workflow in conjunction with the legacy environment. The architects and developers configured the test server system, punched holes in firewalls, implemented the business model and created XML transactions. The business modelers and measurement experts told the developers what to measure and configured the Monitor dashboard. The process owners ensured that the measurements would provide maximum value for process improvement.

Actual production data from the Sub-Capacity Automation process system in Copenhagen was converted to CBE (common business event) format and sent to the Monitor test server in Pittsburgh using IBM's MQSeries product. The portals in the Monitor Dashboard were configured to generate sample charts and reports that gave insight into event characteristics and demonstrated the real time nature of the Monitor.

Process measurements were analyzed in three dimensions (date, country, and geography) using IBM's DB2 Cube and Alphablox drill down graphics. Auxiliary reports were created which isolated data anomalies to specific countries. Specific instances of the CBE events were viewed for the most granular level of diagnosis and analysis. The proof-of-concept live demonstration was shown to management and was well received. Plans are already being made to expand the implementation to other processes.

In exemplary embodiments, XML translations from the legacy system in Copenhagen were submitted directly to the CEI, thereby bypassing a large part of the architectural infrastructure. The XML transactions contained information from the legacy system housed on a mainframe in Copenhagen for the zSeries sub-capacity reporting process. The process server 220 is loaded with a model from WID, which tells the monitor 230 how to interpret the data and how to display the information in the monitor 230. The XML transactions are generated by code written on the legacy systems and then sent real-time to the CEI 225. Whenever a transaction is sent, it is interpreted and reported by the monitor 230, which can be a message to an executive to take real-time action, or it can be an update to graphic charts or both. As such, the systems and methods described herein were adapted to an existing legacy system.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer program product comprising a computer-readable, tangible storage device(s) and computer-readable program instructions stored on the computer-readable, tangible storage device(s) to monitor a process defined in part by a decision tree having different paths based on respective different decisions made in the decision tree, such that different instances of the process in which different decisions are made traverse different respective paths in the decision tree and have different respective outcomes of the decision tree, the computer-readable program instructions, when executed by one or more processors:
identify and monitor the paths of the decision tree that are traversed in performance of the respective instances of the process; and
determine working durations to complete the respective instances of the process, determine performance indicators for the respective instances of the process, and correlate the working durations and the performance indicators to the respective paths in the decision tree.

2. The computer program product of claim 1 further comprising computer-readable program instructions that are stored on the computer-readable, tangible storage device(s) and when executed by the one or more processors:
display on a computer monitor the paths in the decision tree which have satisfied respective metrics for working durations and performance indicators.

3. The computer program product of claim 1 wherein different resources perform respective tasks in the different respective paths through the decision tree.

4. The computer program product of claim 1 wherein the instances of the process generate at least in part a computer implemented transaction.

5. A computer program product comprising a computer-readable, tangible storage device(s) and computer-readable program instructions stored on the computer-readable, tangible storage device(s) to monitor a process defined in part by a decision tree having different paths based on respective different decisions made in the decision tree, such that different instances of the process in which different decisions are made traverse different respective paths in the decision tree and have different respective outcomes of the decision tree, the computer-readable program instructions, when executed by one or more processors:
identify and monitor paths of the decision tree that are traversed in performance of respective instances of the process; and
determine working durations to complete the respective instances of the process, determine performance indicators for the respective instances of the process and correlate the working durations and the performance indicators to the respective paths in the decision tree to determine which paths in the decision tree have satisfied respective metrics for working durations and performance indicators.

6. The computer program product of claim 5 further comprising computer-readable program instructions that are stored on the computer-readable, tangible storage device(s) and when executed by the one or more processors:
display on a computer monitor the paths in the decision tree which have satisfied respective metrics for working durations and performance indicators.

7. The computer program product of claim 5 wherein different resources perform respective tasks in the different respective paths through the decision tree.

8. The computer program product of claim 5 wherein the instances of the process generate at least in part a computer implemented transaction.
